(19) United States
(12) Patent Application Publication
(10) Pub. No.: US 2025/0347263 A1
(43) Pub. Date: Nov. 13, 2025

(54) WIND TURBINE AND WIND POWER PLANT

(71) Applicant: WORLD WIDE WIND TECH AS, Fornebu (NO)

(72) Inventors: Hans BERNOFF, Uppsala (SE); Stian Valentin KNUTSEN, Nesbru (NO)

(21) Appl. No.: 18/868,542

(22) PCT Filed: May 23, 2023
(86) PCT No.: PCT/NO2023/050121

§ 371 Date: Nov. 22, 2024

(30) Foreign Application Priority Data
May 23, 2022 (NO) 20220604
May 25, 2022 (NO) 20220617

(51) Int. Cl. F03D 1/02; F03D 3/02; F03D 13/25

(52) U.S. Cl. CPC F03D 1/025; F03D 3/02; F03D 13/256; F05B 2240/95

(57) ABSTRACT

A contra-rotating wind turbine (10) is disclosed comprising a first turbine rotor (36) mounted on a first turbine shaft (37) and a second turbine rotor (47) mounted on a second turbine shaft (48) where the first turbine shaft (37) is rotatable about a rotational axis (A) and the second turbine shaft (48) is rotatable in the opposite direction about the same rotational axis (A). The first turbine rotor (36) comprises at least one first turbine blade (38) extending in an outwards direction from the first turbine shaft (37) and the second turbine rotor (47) comprises at least one second turbine blade (49) extending in an outwards direction from the second turbine shaft (48). The at least one first turbine blade (38) further forms a first blade angle (40) relative to the first turbine shaft (37) and the at least one second turbine blade (49) forms a second blade angle (51) relative to the second turbine shaft (48) where the first blade angle (40) and the second blade angle (51) are both acute when the wind turbine (10) is operating.

The present invention is related to a contra-rotating wind turbine comprising at least a first turbine rotor mounted and a second turbine rotor which are contra-rotating, and a wind power plant comprising a contra-rotating wind turbine comprising at least a first turbine rotor mounted and a second turbine rotor which are contra-rotating.

### BACKGROUND OF THE INVENTION

Wind is playing an increasingly important role in the ongoing energy transition towards renewables. The global cumulative installed capacity of onshore wind power is estimated to grow more than threefold by 2030 and may increase seven-fold by 2050, and it is expected that the installed wind power capacity will further increase substantially globally towards 2050.

Today there are two main wind turbine technologies, classified by the orientation of the rotational axis of the wind turbines. Three-bladed horizontal-axis wind turbines (HAWT) with the blades upwind of the tower produce make up the overwhelming majority of wind power in the world today. These turbines have the main rotor shaft and electrical generator at the top of a tower and is pointed into the wind. The generator is placed on top of a shaft in a nacelle. The technology relating to such wind turbines is mature, and all horizontal turbines produced and installed today have similar design. The HAWTs have increased in size and installed capacity over the past years and now ranges from 1 MW to 14 MW per turbine. HAWTs are traditionally installed on-shore but are now also being installed on the sea bottom in shallow waters.

A vertical axis wind turbine (VAWT) has its rotational axis perpendicular to the wind direction and is typically installed with a vertical rotational axis relative to the ground. This is therefore a type of wind turbine where the main rotor shaft is set transverse to the wind while the main components can be located at the base of the turbine. This arrangement allows the generator to be located close to the ground, with a low center of gravity, facilitating easy access to service and repair. VAWTs do not need to be pointed into the wind, which removes the need for wind-sensing and orientation mechanisms. VAWT has, however, not received the same attention and investments as HAWTs and today accounts for less than 0.1% of installed wind power capacity.

Existing technology relating to VAWTs have certain drawbacks which can explain the very low attention that VAWTs have received so far. Firstly, the efficiency of traditional Savonius VAWT turbines is lower relative to HAWTs as it is mainly a turbine that relies on drag for its operation and the blades downwind do not contribute to power generation. The smaller Darius turbines are also subject to vibrations from torque exerted on the mast, leading to increased wear & tear and needs for maintenance. And lastly and perhaps most importantly, VAWTs have not received anything near the same amount in investments in research and development as HAWTs and is therefore a much less mature technology.

Generally, a problem with existing wind turbines is the gear system which is subjected to large and varying forces. The gear systems therefore must be designed to be capable of withstanding large and varying forces over time and are therefore costly. The wind turbines still require extensive maintenance and monitoring to prevent and to avoid complete breakdown of the gears.

The weather conditions are often severe in locations where wind turbines are installed, and the design of the wind turbines must compensate for the impact of heavy wind and also waves for wind turbines which are installed offshore. Furthermore, the wind conditions can vary considerably depending on how far from the ground or water surface the wind turbine is mounted.

### Objective of the Invention

Thus, an object of the present invention has been to develop a wind turbine where at least one and preferably some or all of the problems mentioned above are mitigated.

A further object of the present invention has been to develop a wind turbine that can be scaled-up to a much larger sizes than todays installed wind turbines.

A further object of the present invention has been to a wind turbine which can produce substantially more power than known wind turbines today can.

A further object of the present invention has been to develop a wind turbine with a generator that does not need a gear system.

A further object of the present invention has been to provide a wind turbine where the costs of manufacturing, maintenance and monitoring of the gear system of wind turbines is reduced.

### SUMMARY OF THE INVENTION

These objects are met with a contra-rotating wind turbine as defined in claim 1, and with a wind power plant as defined in claim 27. Further embodiments of the present invention are defined in the dependent claims.

Thus, there is provided a contra-rotating wind turbine comprising at least a first turbine rotor mounted on a first turbine shaft and a second turbine rotor mounted on a second turbine shaft where the first turbine shaft is rotatable about a rotational axis (A) and the second turbine shaft is rotatable in the opposite direction about the same rotational axis (A), wherein the first turbine rotor comprises at least one first turbine blade extending in an outwards direction from the first turbine shaft, and wherein the second turbine rotor comprises at least one second turbine blade extending in an outwards direction from the second turbine shaft.

The at least one first turbine blade may form a first blade angle relative to the first turbine shaft and the at least one second turbine blade forms a second blade angle relative to the second turbine shaft, the first blade angle and the second blade angle both being acute, at least when the wind turbine is operating, but possibly also when it is not operating.

Thus, preferably the at least one first turbine blade has a first longitudinal axis which makes a first blade angle with the rotational axis (A) such that the first longitudinal axis forms a conical shape when the at least one first turbine blade is rotating about the rotational axis (A) and/or the at least one second turbine blade preferably has a second longitudinal axis which makes a second blade angle with the rotational axis (A) such that the second longitudinal axis forms a conical shape when the at least one second turbine blade is rotating about the rotational axis (A). The at least one first turbine blade and the at least one second turbine blade, therefore, preferably swipe respective conically shaped areas when they are rotating about the rotational axis (A).

The at least one first rotor blade, therefore, preferably swipes a conically shaped area and/or the at least one second rotor blade preferably swipes a conically shaped area when the contra-rotating wind turbine is operating.

The rotational axis (A) preferably forms an acute angle with a horizontal plane when the wind turbine is operating. Thus, the wind turbine has rotational axis that is inclined relative to the direction of the wind, at least when the wind turbine is operating.

The first turbine rotor, in operation, swipes a first swept area and the second turbine rotor, in operation, swipes a second swept area, and preferably the first turbine rotor and the second turbine rotor are configured so that the first swept area and the second swept area are substantially non-overlapping when the rotational axis (A) is vertical.

The second turbine shaft is preferably rotatably mounted within the first turbine shaft, such that the first turbine shaft and the second turbine shaft are co-axial.

The at least one first turbine blade is mounted or attached to the first turbine shaft with a first connecting device, and wherein the at least one second turbine blade is mounted to the second turbine shaft with a second connecting device.

The first longitudinal axis of the at least one first turbine blade preferably extends from an outer tip of the at least one first turbine blade to a center point of the first connecting device and/or the second longitudinal axis of the at least one second turbine blade preferably extends from the outer tip of the at least one second turbine blade to a center point of the second connecting device.

The first connecting device is preferably configured to allow adjustment of the first blade angle and/or the second connecting device is preferably configured to allow adjustment of the second blade angle.

The first blade angle and the second blade angle can preferably be adjusted independently, or separately, of each other.

The first connecting device is preferably configured to allow adjustment of the pitch of the at least one first turbine blade and/or the second connecting device is preferably configured to allow adjustment of the pitch of the at least one first turbine blade.

The first blade angle and the second blade angle are preferably adjusted in dependency of each other, for example so that the first blade angle and the second blade angle are equal after an adjustment is made.

The first blade angle can preferably be adjusted so that it is less than 70 degrees and larger than 20 degrees and/or the second blade angle can preferably be adjusted so that it is less than 70 degrees and larger than 20 degrees.

More preferably, the first blade angle can preferably be adjusted so that it is less than 50 degrees and larger than 40 degrees and/or the second blade angle can preferably be adjusted so that it is less than 50 degrees and larger than 40 degrees.

The at least one first wind turbine blade is preferably airfoil-shaped and/or the at least one second wind turbine blade is preferably airfoil-shaped.

The first turbine rotor preferably comprises at least one first support arm which is mounted to the first turbine blade and to the first turbine shaft, and the second turbine rotor preferably comprises at least one second support arm which is mounted to the second turbine blade and to the second turbine shaft.

The at least one first support arm is preferably mounted to the first turbine blade and to an upper side of the first turbine shaft and/or the at least one second support arm is preferably mounted to the second turbine blade and to an upper side of the second turbine shaft. As a consequence, the first turbine shaft preferably extends so far that the first support arm can be mounted to it.

The length of the at least one first support arm is preferably adjustable such that the first blade angle, i.e. the angle between the at least one first turbine blade and the rotational axis, can be adjusted. The at least one first support arm may, for example, comprise two or more telescopic sections to adjust the length of the at least one first support arm.

The length of the at least one second support arm is preferably adjustable such that the second blade angle, i.e. the angle between the at least one second turbine blade and the rotational axis, can be adjusted. The at least one second support arm may, for example, comprise two or more telescopic sections to adjust the length of the at least one second support arm.

A swept area of the first turbine rotor is preferably 0-20% larger than a swept area of the second turbine rotor.

The at least one first support arm is preferably airfoil-shaped and/or the at least one second support arm is preferably airfoil-shaped.

The at least one first support arm and/or the at least one second support arm is provided with a motion damper device. The motion damper device which is preferably configured to be capable of damping/reducing shocks and/or vibrations.

The first support arm preferably makes an angle which is less than 135 degrees and larger than 45 degrees with the at least one first turbine blade, and/or the second support arm preferably makes an angle which is less than 135 degrees and larger than 45 degrees with the at least one second turbine blade.

More preferably, the first support arm preferably makes an angle which is less than 120 degrees and larger than 70 degrees with the at least one first turbine blade, and/or the second support arm preferably makes an angle which is less than 120 degrees and larger than 70 degrees with the at least one second turbine blade.

The at least one first turbine blade is preferably provided with a first winglet mounted to a tip portion of the at least one first turbine blade and/or the at least one second turbine blade is preferably provided with a second winglet mounted to a tip portion of the at least one second turbine blade.

The first winglet is preferably arranged substantially perpendicularly to the longitudinal axis of the at least one first turbine blade and/or the second winglet is preferably arranged substantially perpendicularly to the longitudinal axis of the at least one second turbine blade.

The first winglet may be mounted with its concave side facing towards the first turbine blade or with its concave side facing away from the first turbine blade. Similarly, the second winglet may be mounted with its concave side facing towards the second turbine blade or with its concave side facing away from the second turbine blade.

The first winglet is preferably adjustably mounted to the at least one first turbine blade and/or the second winglet is preferably adjustably mounted to the at least one second turbine blade.

The first winglet is preferably airfoil-shaped and/or the second winglet is preferably airfoil-shaped.

The length of the at least one first turbine blade is preferably larger than the diameter of the first turbine shaft and/or the length of the at least one second turbine blade is preferably larger than the diameter of the second turbine shaft.

The length of the at least one first turbine blade is preferably substantially larger than the diameter of the first turbine shaft, and/or the length of the at least one second turbine blade is preferably substantially larger than the diameter of the second turbine shaft.

The at least one first turbine blade preferably comprises a plurality of first blade segments which are connected or attached to each other and/or the at least one second turbine blade preferably comprises a plurality of second blade segments which are connected or attached to each other.

Two adjacent first blade segments are preferably attached to each other at an angle so that they form a non-straight first turbine blade and/or two adjacent second blade segments are preferably attached to each other at an angle so that they form a non-straight second turbine blade.

At least one pair of adjacent first blade segments are preferably articulately attached to each other and/or at least one pair of two adjacent second blade segments are preferably articulately attached to each other.

Tt least one first blade segment is preferably attached to the at least one first support arm and/or at least one second blade segment is preferably attached to the at least one second support arm.

At least a part of the at least one first turbine blade may be curved upwards or downwards with respect to the direction of the rotational axis (A) and/or at least a part of the at least one second turbine blade may be curved upwards or downwards with respect to the direction of the rotational axis (A).

At least a part of the at least one first turbine blade may be curved forwards or backwards with respect to the rotational direction of the first turbine rotor and/or at least a part of the at least one second turbine blade may be curved forwards or backwards with respect to the rotational direction of the second turbine rotor. The at least one first turbine blade at least partly may be curved in a circumferential direction around the first turbine shaft and/or the at least one second turbine blade at least partly may be curved in a circumferential direction around the second turbine shaft.

There is also provided a wind power plant comprising a contra-rotating wind turbine comprising none of the additional features above, one of the additional features above, some of the additional features above or all of the additional features above.

The wind power plant preferably comprises a generator which is driven by the contra-rotating wind turbine.

The generator is preferably a synchronous generator.

More preferably, the generator is preferably a permanent magnet synchronous generator. The permanent magnet synchronous generator may, for example, including NeodyniumIronBor magnets or Ferrite magnets.

The armature windings preferably comprise a high voltage cable.

The first turbine shaft is preferably mounted to a stator part of the generator and the second turbine shaft is preferably mounted to a rotor part of the generator.

The stator part may be defined as the part of the generator which comprises the armature winding.

The stator part on the rotating first turbine shaft preferably comprises a rectifier such that a direct current can be transmitted through a rotating contact. The rotating contact may comprise, for example, a slip ring or liquid metal contacts.

The generator is preferably dimensioned so that loads up to 1-5 times the rated power, preferably 2-3 times the rated power. This will allow operational control of the first and second wind turbines even in stormy weather conditions.

The rectifier is preferably configured for active rectification or rectification with diodes.

The absorption of the effect of the first wind turbine and/or the second wind turbine is preferably controlled by controlling the rotational speed of the first and/or second wind turbines, i.e. stall control, through the torque of the generator which can be controlled with active rectification or passive rectification with a choice of voltage level on the direct current side of the rectifier.

The stator part preferably comprises a first stator part and a second stator part where the first stator part preferably is non-rotatable and the second stator part preferably is rotatable.

The non-rotatable first stator part is mounted to a tower section of the wind power plant and the rotatable second stator part is mounted to the first turbine shaft.

The static first stator part is preferably configured so that it can be used as a motor whereby a torque can be applied to the second turbine shaft.

The contra-rotating turbine, in operation, is preferably configured so that the rotational axis (A) is inclined relative to a horizontal plane.

The wind power plant is preferably configured so that, in operation, the at least one first turbine blade makes a first blade angle with the rotational axis (A) which is substantially equal to the inclination of the rotational axis (A) relative to a horizontal plane and/or the at least one second turbine blade makes a second blade angle with the rotational axis (A) which is substantially equal to the inclination of the rotational axis (A) relative to a horizontal plane.

The at least one first turbine blade may be arranged so that the at least one first turbine blade is substantially vertical when the first blade tip portion is at a highest position of its rotational path.

The at least one second turbine blade may be arranged so that the at least one second turbine rotor is substantially vertical when the second blade tip is at a highest position of its rotational path.

The wind power plant may be an on-shore wind power plant.

The wind power plant may also be a floating wind power plant, i.e. a wind power plant which is adapted to be arranged floating in a body of water.

The wind power plant preferably comprises at least one hydrofoil which is arranged so that it is below a water surface of the body of water, the at least one hydrofoil being adjustable to provide a desired moment on the wind power plant when there is a water current in the body of water.

The tower of the wind power plant is preferably mounted to an anchoring system.

The anchoring system is preferably configured to take up any torque produced by the generator.

The generator may be configured so that it can be used as a motor whereby a torque can be applied between the first and second turbine shafts. This will allow the generator to be used as a motor in order to start the rotation of the first and second turbine rotors.

The tower preferably comprises at least one buoyancy unit and/or a ballast unit.

The tower is preferably made of steel, aluminium, wood or a combination of these materials.

The buoyancy unit and/or the ballast unit and/or the generator housing is/are preferably made of steel or concrete or a combination of steel and concrete.

The first turbine shaft and/or the second turbine shaft is/are preferably made of steel, aluminium, wood or a combination of these materials.

The at least one first turbine blade and/or the second turbine blade and/or the first turbine shaft and/or the second turbine shaft is/are preferably made of a composite material, steel, aluminium, wood or a combination of these materials. The joints that connects the first and second support arms to the first and second turbine blades and to first and second turbine shaft preferably have rotational freedom in at least one dimension so that no bending moment is transferred by the joint.

All bearings of the wind power plant are preferably equipped with a monitoring system that allows remote monitoring of the state of the bearing.

The contra-rotating wind turbine is preferably equipped with Supervisory control and data acquisition (SCADA).

A stationary platform mooring and power take off cable connection is preferably mounted to the lower end of the second turbine shaft. The stationary platform may have hydrodynamic damper plates to increase rotational stability and relieve any torque fluctuations from mooring system.

The power cable connected to said platform mooring preferably connects to a subsea ocean floor substation or connection point for power transmission to shore.

The tower preferably comprises at least one buoyancy unit and/or preferably a ballast unit.

The tower preferably comprises a buoyancy unit adapted to be positioned at the surface of a body of water in which the wind power plant is arranged.

A lower part of the tower preferably comprises a nacelle which preferably includes a ballast unit. Thus, the ballast unit may form part of a nacelle of the wind power plant.

The nacelle may further be provided with hydrodynamic wings on the outside. The wings can be controlled to provide a stabilizing effect on the wind power plant.

The mooring system is preferably rotatably attached to the ballast unit, for example with a turret, but other attachment means may also be used for attachment of the mooring system to the wind power plant.

### BRIEF DESCRIPTION OF THE DRAWINGS

A non-limiting embodiment of the present invention will now be described with reference to the attached figures, where

FIG. 1 shows a perspective view of a wind power plant comprising a contra-rotating wind turbine according to the present invention where the wind power plant is arranged off-shore floating in a body of water.

FIG. 2 shows a perspective view of a wind power plant comprising a contra-rotating wind turbine according to the present invention which may be mounted to a suitable foundation on-shore.

FIG. 3 shows a perspective view of a wind power plant comprising a contra-rotating wind turbine according to the present invention where the wind power plant is arranged off-shore floating in a body of water.

FIG. 4 illustrates an example of the swept areas of the first and second wind turbine rotors when the first and second turbine shafts of the first and second wind turbines respectively are inclined relative to a vertical line.

FIG. 5 illustrates an imaginary volume outlined by the at least one first turbine blade or at least one second turbine blade when the first turbine shaft or the second turbine shaft respectively is inclined relative to a vertical line.

FIG. 6 illustrates a wind power plant comprising a contra-rotating wind turbine according to the present invention where the first blade tip of first turbine blades and the second blade tip of the second turbine blades are provided with respective winglets.

FIG. 7 illustrates the adjustable attachment of the first and second turbine blades to the first and second turbine shafts whereby the first and second blade angle can be adjusted.

FIG. 8 illustrates the lower part of the wind power plant including a buoyancy unit and a nacelle comprising the generator where the nacelle is rotatably connected to the mooring system.

FIG. 9 illustrates shows a turbine blade that can be used with the present invention.

FIG. 10 illustrates in more detail how the first and second turbine blades shown in FIG. 9 can be attached to the first and second turbine shafts respectively.

### DETAILED DESCRIPTION OF THE DRAWINGS

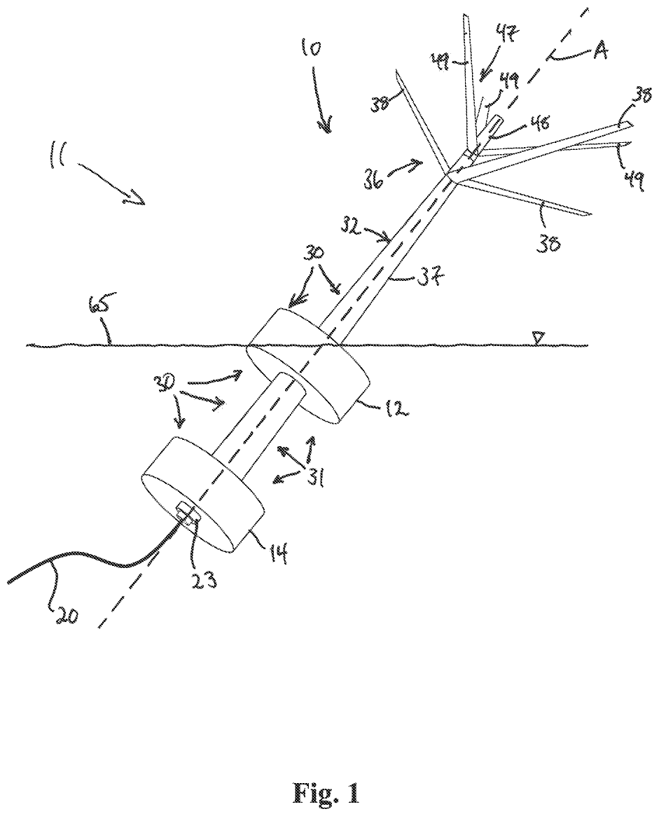

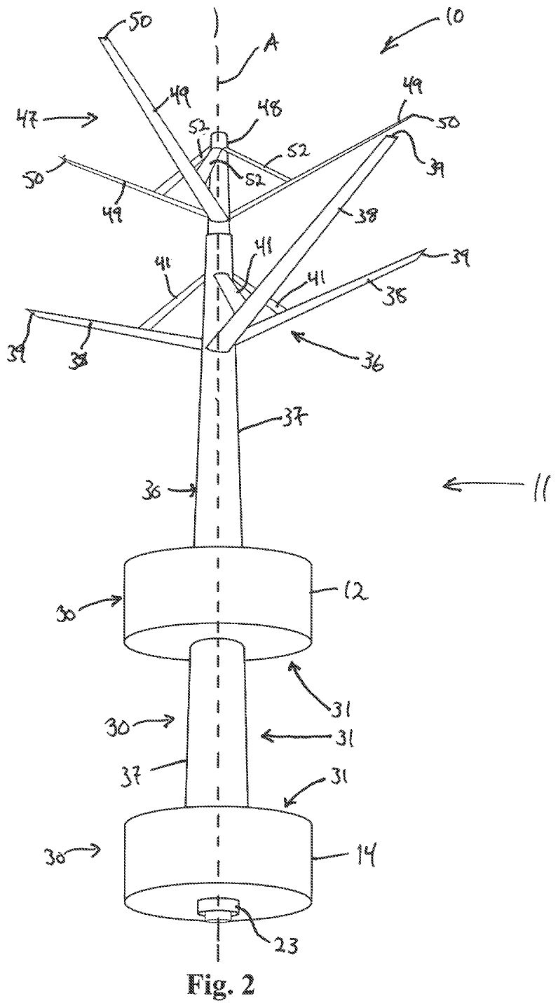

In FIGS. 1-10 an embodiment of a wind turbine 10 according to the present invention arranged on a wind power plant 11, also according to present invention.

In FIG. 1, there is shown a wind power plant 11 comprising a wind turbine 19. The wind power plant 11 shown in the figures is a semisubmersible wind power plant floating in a body of water with a surface 65.

The wind power plant 11 comprises a first turbine rotor 36 and a second turbine rotor 47. The first turbine rotor 36 comprises at least one first turbine blade 38, but preferably a plurality of first turbine blades 38 as shown in the figures. The first turbine blades 38 are mounted on a first turbine shaft 37. The first turbine shaft 37 is rotatable about a rotational axis A.

The second turbine rotor 47 comprises at least one second turbine blade 49, but preferably a plurality of second turbine blades 49 as shown in the figures. The second turbine blades 49 are mounted on a second turbine shaft 48. The second turbine shaft 48 is rotatable about the same rotational axis A.

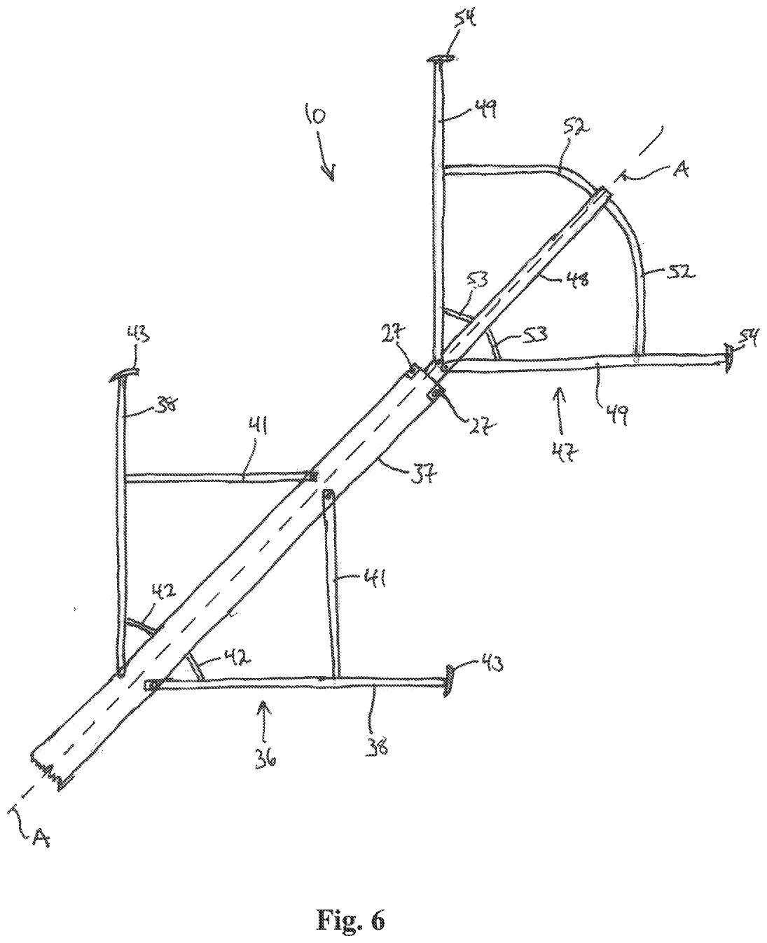

As indicated in FIG. 6, the first turbine blades 38 and the second turbine blades 49 may be provided with respective first winglets 43 and second winglets 54 mounted to the first blade tips 39 and the second blade tips 50 respectively.

The first turbine rotor 36 and the second turbine rotor 47 are arranged such that they are contra-rotating. Thus, they are co-axial and rotates about the same rotational axis A in opposite directions.

When the wind power plant 11 comprises a tower 30. When the wind power plant 11 is operating, the tower 30, and thereby the rotational axis A, will be arranged so that the tower 30 and the rotational axis A is inclined relative to a horizontal plane as indicated in the figures.

As indicated in the figures, the first turbine shaft 37 can be considered to form at least a part of an upper part 32 of the tower 30 of the wind power plant 11.

The lower part 31 of the tower 30 comprises a buoyancy unit 12. The buoyancy unit 12 can be arranged so that it is partly submerged in the water as indicated in the figures. The buoyancy unit 12 can also be arranged so that it is completely submerged in the water.

The lower part 31 of the tower 30 further comprises a nacelle 14. The generator 17 of the wind power plant 11 is driven by the contra-rotating first turbine shaft 37 and second turbine shaft 48 of the wind turbine 10 and is arranged in the nacelle 14.

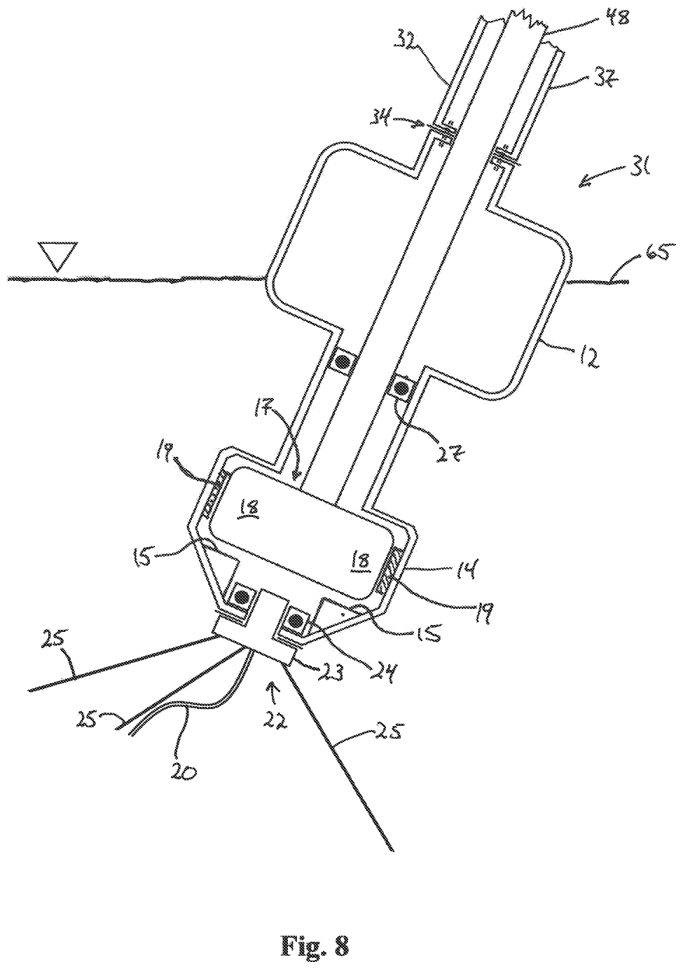

The generator 17 comprises a stator part 18 mounted to the second turbine rotor 48 and a rotor part 19 mounted to the first turbine rotor 37, i.e. the nacelle 14 as indicated in FIG. 8. The generator 17 is preferably a permanent magnet synchronous generator. The rotor part 19 of the generator 17 may, for example, include NeodyniumIronBor magnets or Ferrite magnets while stator part 18 of the generator 17 comprises the armature windings which preferably comprise a high voltage cable.

The generator 17 produces electric power which can be exported to an external consumer or an external storage facility through at least one export cable 20.

The lower part 31 of the tower 30 is preferably securely attached to the upper part 32 of the tower 30 with a connecting device 34. The connecting device 34 may, for example, be a conventional flange connection where the lower part 31 and the upper part 32 of the tower 30 are provided with respective flanges which are bolted together with a suitable number of bolts as indicated in FIG. 8. The lower part 31 and the upper part 32 of the tower 30 are thereby non-rotatably connected and the lower part 31 and the upper part 32 of the tower 30 will rotate together when the wind power plant 11 is operating.

The second turbine shaft 48 passes through the buoyancy unit 12 and into the nacelle 14 and is rotatably supported in the tower 30 by a plurality of bearing devices 27. Such bearing devices 27 are indicated in FIGS. 6 and 8. Thus, the second turbine shaft 48 is rotatable relative to the tower 30 including the buoyancy unit 12 and the nacelle 14.

At the lower end of the tower 30 and the nacelle 14, there is provided a mooring device 22 comprising a mooring line connector 23. The mooring line connector 23 is rotatably supported by a bearing device 24 that is arranged in the nacelle 14 as shown in FIG. 8. The mooring line connector 23 is designed to allow relative movement between the mooring line connector 23 and the nacelle 14. The mooring line connector 23 can, for example, be a turret which allows relative rotation between the turret and the nacelle 14.

The mooring device 22 further comprises at least one, but preferably a plurality of mooring lines 25 which are attached to the mooring line connector 23 in one end and for example to the seabed in the other end. The mooring system 22 is preferably of a well-known design, for example as used for anchoring of semi-submersible vessels and will not be any further described here.

The lower part 31 of the tower 30 is preferably provided with one or more ballast units 15 as indicated in FIG. 8. The ballast units 15 can be ballast tanks for water such that the amount of extra weight at the lower part 31 of the tower 30 can be adjusted. Alternatively, the ballast units may be solid weights, for example made of steel or iron which is arranged in the nacelle 14. The ballast unit may also comprise a combination of ballast tanks and solid weights.

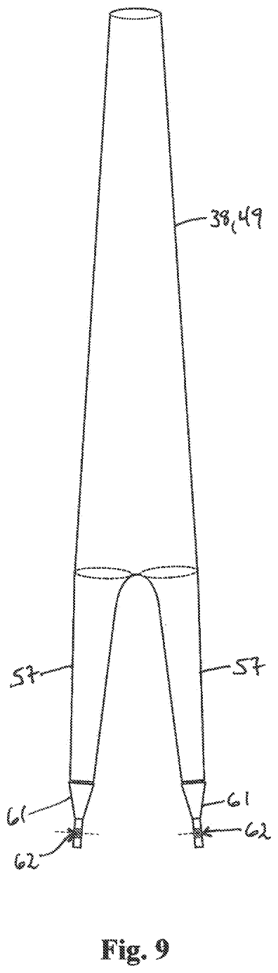

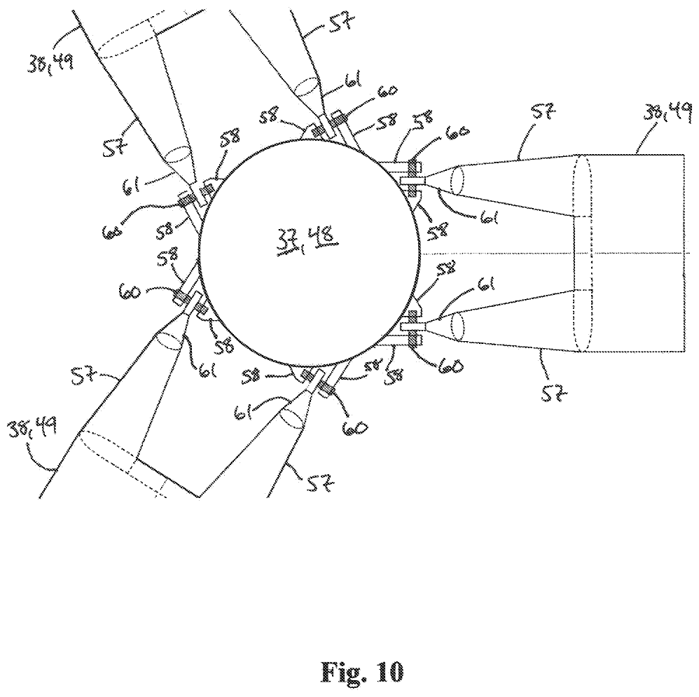

As shown in FIGS. 9 and 10, the first turbine blade 38 and the second turbine blade 49 are provided with at least one, but preferably a plurality of connecting arms 57, for example two connecting arms 57 as indicated in the figures. The connecting arms 57 can be an integral part of the first turbine blades 38 and the second turbine blades 49 as indicated in the figures. Alternatively, the connecting arms 57 can be separate parts which are securely fastened to the first turbine blades 38 and second turbine blades 49 with suitable fastening means.

At the end of the connecting arms 57 there is provided blade connectors 61. The blade connectors 61 can be an integral part of the first turbine blades 38 and the second turbine blades 49. Alternatively, the blade connectors 61 can be separate parts which are securely fastened to the connecting arms 57 with suitable fastening means. The blade connectors 61 are provided with a bolt hole 62 as shown in FIG. 9.

The first turbine shaft 38 and the second turbine shaft 49 are provided with bolt connectors 58 which are securely attached to the first turbine shaft 38 and the second turbine shaft 49, for example by welding. The bolt connectors 58 are provided with bolt holes corresponding to the bolt holes 62 on the blade connectors 61 and bolts 60 are arranged through the bolt holes of the bolt connectors 58 and the bolt holes 62 of the blade connectors 61. The first turbine blade 38 and the second turbine blade 49 are thereby rotatably connected to the first turbine shaft 37 and the second turbine shaft 48 respectively, rotatable about the bolts 60.

The first turbine rotor 36 is preferably provided with at least one first support arm 41. The number of support arms 41 will normally be the same as the number of first turbine blades 38. The length of the first support arms 41 may be adjustable or fixed.

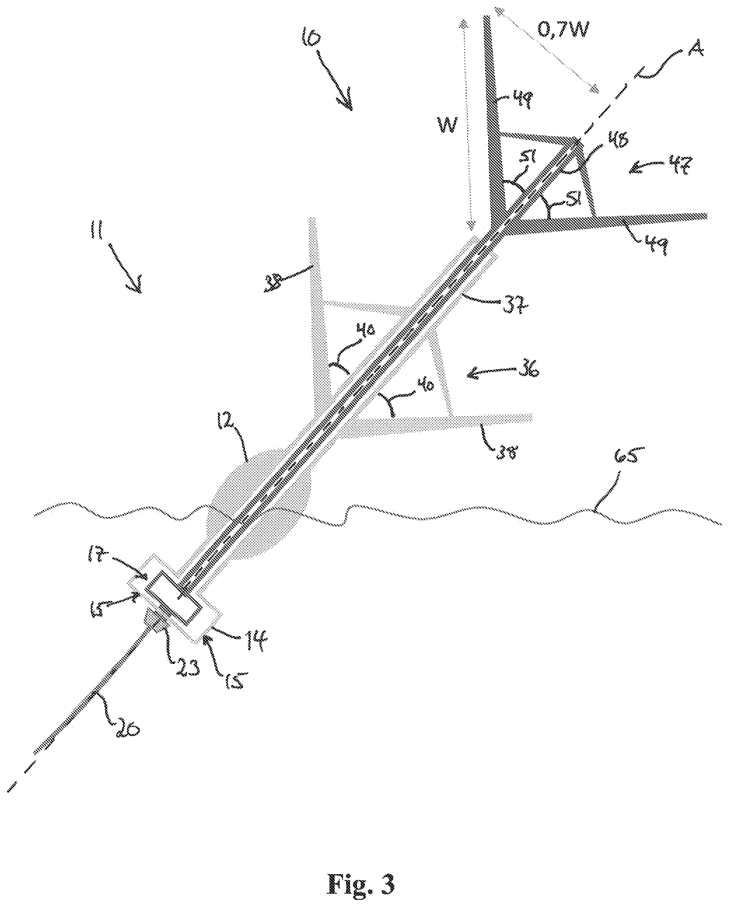

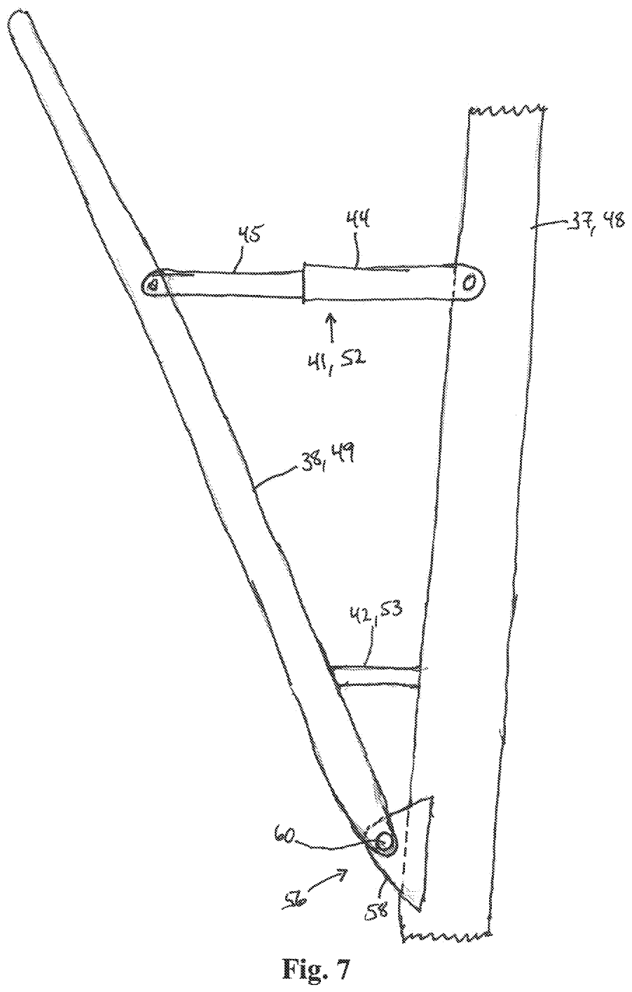

The first support arms 41 can be rotatably attached to the first turbine blades 38 in one end and rotatably attached to the first turbine shaft 37 in the other end. Furthermore, the first support arms 41 may comprise a first telescopic section 44 and a second telescopic section 45 as indicated in FIG. 7. The first blade angle 40 (see FIG. 3), which is the angle between the first turbine blades 38 and the first turbine shaft 37, is thereby adjustable. Alternatively, the first support arms 41 may be slidingly attached in one end to either the first turbine blade 38 or, more preferably, to the first turbine shaft 37 in order to adjust the angle between the first turbine blades 38 and the first turbine shaft 37. The inclination of the first turbine blades 38 relative to the first turbine shaft 37 is thereby adjustable, but in such a way that the first blade angle 40 is an acute angle.

Similarly, the second turbine rotor 47 is preferably provided with at least one second support arm 52. The number of second support arms 52 will normally be the same as the number of second turbine blades 49. The length of the second support arms 52 may be adjustable or fixed.

The second support arms 52 can be rotatably attached to the second turbine blades 49 in one end and rotatably attached to the second turbine shaft 48 in the other end. Furthermore, the second support arms 52 may comprise a first telescopic section 44 and a second telescopic section 45 as indicated in FIG. 7. The second blade angle 51 (see FIG. 3), which is the angle between the second turbine blades 49 and the second turbine shaft 48, is thereby adjustable. Alternatively, the second support arms 52 may be slidingly attached in one end to either the second turbine blade 49 or, more preferably, to the second turbine shaft 48 in order to adjust the angle between the second turbine blades 49 and the second turbine shaft 48. The inclination of the second turbine blades 49 relative to the second turbine shaft 48 is thereby adjustable, but preferably in such a way that the second blade angle 51 is an acute angle.

In FIG. 3, the inclination of the first turbine blades 38 relative to the first turbine shaft 37 (and the rotational axis A) is between 40 and 50 degrees, and more closely about 45 degrees. The inclination of the second turbine blades 49 relative to the second turbine shaft 48 (and the rotational axis A) is also between 40 and 50 degrees, and more closely about 45 degrees.

Furthermore, the inclination of the tower 30 and the rotational axis A relative to a horizontal plane, and thus relative to the surface 65 of the water, is between 40 and 50 degrees, and more closely about 45 degrees.

When the first blade angle 40 is about the same as the inclination of the rotational axis A relative to a horizontal plane, the first turbine blades 38 will be in a more or less horizontal position when the first blade tips 39 are at their lowest position. Thereby, the chance that the first turbine blades 38 will hit the water is reduced. At the same time the first turbine blades 38 will be more or less in a vertical position when the first blade tips 39 are at their highest vertical position and an optimal swept area is obtained.

When the second blade angle 51 is about the same as the inclination of the rotational axis A relative to a horizontal plane, the second turbine blades 49 will also be in a more or less horizontal position when the second blade tips 50 are at their lowest position. At the same time the second turbine blades 49 will be more or less in a vertical position when the second blade tips 50 are at their highest vertical position and an optimal swept area is obtained.

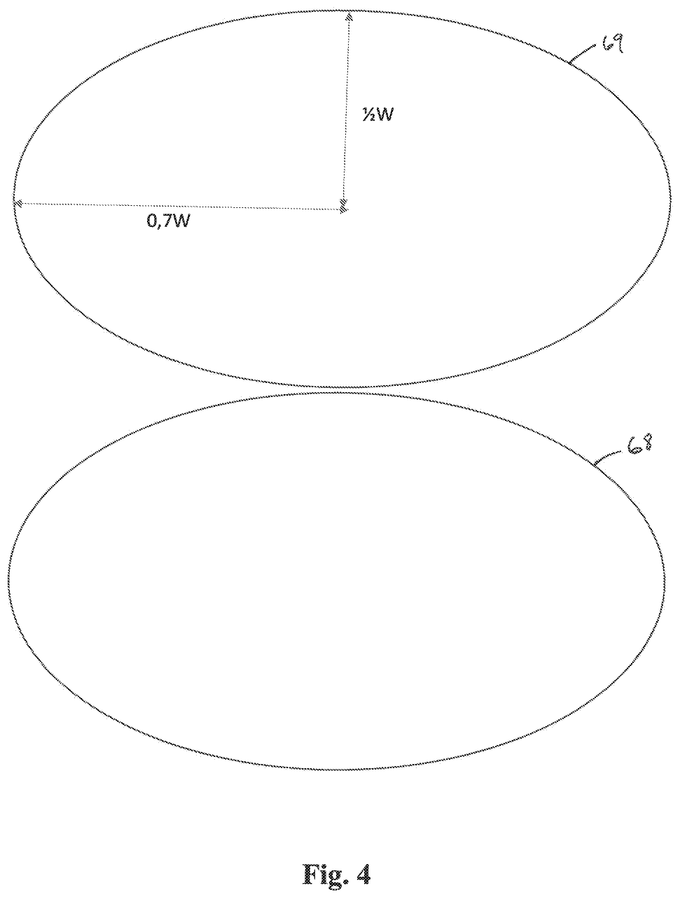

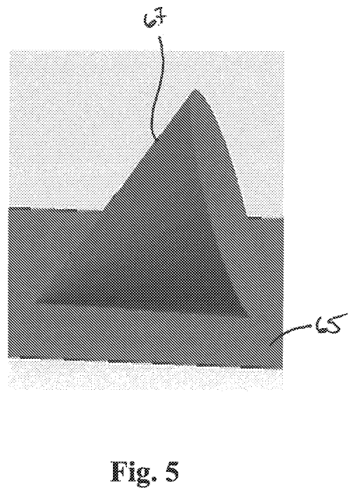

When the first turbine rotor 36 and the second turbine rotor 47 rotates, the first turbine blades 38 and the second turbine blades will swipe a conically shaped area 67 as indicated in FIG. 5. The swept area 68 swept by the first rotor blades 38 and the swept area 69 swept by the second rotor blades will have an elliptical shape in a vertical projection as indicated in FIG. 4.

As shown in FIG. 6, the first support arm 41 and the second support arm 52 may be either straight or curved.

The first turbine rotor 36 may further be provided with a first support strut 42, for example if the first blade angle 40 is fixed and no adjustment of the inclination of the first turbine blade 38 relative to the first turbine shaft 38 is possible, where the first support strut is attached in one end to the first turbine blade 38 and in the other end to the first turbine shaft 37.

The second turbine rotor 47 may further be provided with a second support strut 53, for example if the second blade angle 51 is fixed and no adjustment of the inclination of the second turbine blade 49 relative to the second turbine shaft 48 is possible, where the second support strut 53 is attached in one end to the second turbine blade 49 and in the other end to the second turbine shaft 48.

Reference numbers used in the description of the drawings:

| | |
|---|---|
| 10 | Wind turbine (contra-rotating) |
| 11 | Wind power plant |
| 12 | Buoyancy unit (preferably arranged submerged or partly |
| | submerged in the water) |
| 14 | Nacelle (submerged in the water) |
| 15 | Ballast unit (part of the nacelle) |
| 17 | Generator |
| 18 | Stator part (including windings that rotate with the first generator |
| | part) |
| 19 | Rotor part (including magnets that rotate with the second |
| | generator part) |
| 20 | Export cable (for transfer of electric power from the wind power |
| | plant to grid, consumer, storage device etc.) |
| 22 | Mooring device |
| 23 | Mooring line connector (for example a turret which allows the |
| | nacelle to rotate relative to the mooring line connector) |
| 24 | Bearing device (for mooring line connector) |
| 25 | Mooring line |
| 27 | Bearing device (supporting second turbine shaft in first turbine |
| | shaft/tower) |
| 30 | Tower |
| 31 | Lower part (of the tower - comprising buoyancy unit and nacelle |
| | with generator and ballast unit) |
| 32 | Upper part (of tower - first turbine shaft) |
| 34 | Connecting device (connecting lower part of tower to upper part) |
| 36 | First turbine rotor |
| 37 | First turbine shaft |
| 38 | First turbine blade |
| 39 | First blade tip |
| 40 | First blade angle |
| 41 | First support arm |
| 42 | First support strut |
| 43 | First winglet |
| 44 | First telescopic section (of first/second support arm) |
| 45 | Second telescopic section (of first/second support arm) |
| 47 | Second turbine rotor |
| 48 | Second turbine shaft |
| 49 | Second turbine blade |
| 50 | Second blade tip |
| 51 | Second blade angle |
| 52 | Second support arm |
| 53 | Second support strut |
| 54 | Second winglet |
| 56 | Turbine blade connecting device |
| 57 | Connecting arm (arranged on the turbine blades - preferably |
| | two connecting arms on each blade) |
| 58 | Bolt connector (arranged on the first and/or second turbine shafts) |
| 59 | Bolt hole (on bolt connectors) |
| 60 | Bolt element |
| 61 | Blade connector (arranged on the connecting arms) |
| 62 | Bolt hole (on blade connectors) |
| 65 | Surface (of a body of water in which the wind power plant is |
| | arranged) |
| 67 | Conically shaped area (swept by the first and second rotor blades) |
| 68 | Swept area (by the first rotor blades) |
| 69 | Swept area (by second rotor blades) |

1. A contra-rotating wind turbine comprising a first turbine rotor mounted on a first turbine shaft and a second turbine rotor mounted on a second turbine shaft where the first turbine shaft is rotatable about a rotational axis (A) and the second turbine shaft is rotatable in the opposite direction about the same rotational axis (A), wherein the first turbine rotor comprises at least one first turbine blade extending in an outwards direction from the first turbine shaft, and wherein the second turbine rotor comprises at least one second turbine blade extending in an outwards direction from the second turbine shaft, wherein the at least one first turbine blade forms a first blade angle relative to the first turbine shaft and the at least one second turbine blade forms a second blade angle relative to the second turbine shaft, the first blade angle and the second blade angle both being acute when the wind turbine is operating.

2. The contra-rotating wind turbine according to claim 1,
wherein the rotational axis (A) forms an acute angle with a horizontal plane when the wind turbine is operating.

3. The contra-rotating wind turbine according to claim 1, wherein the at least one first turbine blade and the at least one second turbine blade swipe respective conically shaped areas when they are rotating about the rotational axis (A).

4. The contra-rotating wind turbine according to claim 1, wherein the first turbine rotor, in operation, swipes a first swept area and the second turbine rotor, in operation, swipes a second swept area, and wherein the first turbine rotor and the second turbine rotor are configured so that the first swept area and the second swept area are substantially non-overlapping when the rotational axis (A) is vertical.

5. The contra-rotating wind turbine according to claim 1, wherein the at least one second turbine blade and the at least one second turbine blade are arranged so that the at least one first turbine blade and the at least one second turbine rotor are substantially vertical when the second blade tip is at a vertically highest position of its rotational path.

6. The contra-rotating wind turbine according to claim 1, wherein the at least one first turbine blade is mounted or attached to the first turbine shaft with a first connecting device, and wherein the at least one second turbine blade is mounted to the second turbine shaft with a second connecting device.

7. The contra-rotating wind turbine according to claim 1, wherein the first connecting device is configured to allow adjustment of the first blade angle and/or the second connecting device is configured to allow adjustment of the second blade angle.

8. The contra-rotating wind turbine according to claim 1, wherein the first blade angle and the second blade angle are adjustable independently of each other.

9. The contra-rotating wind turbine according to claim 1, wherein the first blade angle can be adjusted so that it is less than 70 degrees and larger than 20 degrees and/or the second blade angle can be adjusted so that it is less than 70 degrees and larger than 20 degrees.

10. The contra-rotating wind turbine according to claim 1, wherein the first blade angle can be adjusted so that it is less than 50 degrees and larger than 40 degrees and/or the second blade angle can be adjusted so that it is less than 50 degrees and larger than 40 degrees.

11. The contra-rotating wind turbine according to claim 1, wherein the at least one first wind turbine blade is airfoil-shaped and/or the at least one second wind turbine blade is airfoil-shaped.

12. The contra-rotating wind turbine according to claim 1, wherein the first turbine rotor comprises at least one first support arm which is mounted to the first turbine blade and to the first turbine shaft, and the second turbine rotor comprises at least one second support arm which is mounted to the second turbine blade and to the second turbine shaft.

13. The contra-rotating wind turbine according to claim 1, wherein a swept area of the first turbine rotor is 0-20% larger than a swept area of the second turbine rotor.

14. The contra-rotating wind turbine according to claim 1, wherein the at least one first support arm is airfoil-shaped and/or the at least one second support arm is airfoil-shaped.

15. The contra-rotating wind turbine according to claim 1, wherein the at least one first support arm and/or the at least one second support arm is provided with a motion damper device.

16. The contra-rotating wind turbine according to claim 1, wherein the at least one first turbine blade is provided with a first winglet mounted to a tip portion of the at least one first turbine blade and/or the at least one second turbine blade is provided with a second winglet mounted to a tip portion of the at least one second turbine blade.

17. The contra-rotating wind turbine according to claim 16,
wherein the first winglet is adjustably mounted to the at least one first turbine blade and/or the second winglet is adjustably mounted to the at least one second turbine blade.

18. The contra-rotating wind turbine according to claim 16, wherein first winglet is airfoil-shaped and/or the second winglet is airfoil-shaped.

19. The contra-rotating wind turbine according to claim 1, wherein the length of the at least one first turbine blade is larger than the diameter of the first turbine shaft, and wherein the length of the at least one second turbine blade is larger than the diameter of the second turbine shaft.

20. The contra-rotating wind turbine according to claim 1, wherein the at least one first turbine blade comprises a plurality of first blade segments which are connected or attached to each other and/or the at least one second turbine blade comprises a plurality of second blade segments which are connected or attached to each other.

21.-44. (canceled)
